(19) United States
(12) Patent Application Publication
(10) Pub. No.: US 2026/0072533 A1
(43) Pub. Date: Mar. 12, 2026

(54) POSITION INPUT SYSTEM, POSITION INDICATOR, AND COMMUNICATION METHOD

(71) Applicant: Wacom Co., Ltd., Saitama (JP)

(72) Inventor: Takahiro MORISHITA, Saitama (JP)

(73) Assignee: Wacom Co., Ltd., Saitama (JP)

(21) Appl. No.: 19/314,580

(22) Filed: Aug. 29, 2025

(30) Foreign Application Priority Data
Sep. 6, 2024 (JP) 2024-153632

(51) Int. Cl. G06F 3/038; G06F 3/0354; H04W 60/00

(52) U.S. Cl. CPC G06F 3/038; G06F 3/03545; H04W 60/00

(57) ABSTRACT

A position input system includes a position indicator for indicating a position, and a plurality of position detection apparatuses that receive the indication made by the position indicator. The position indicator includes a wireless communication circuit that uses a master-slave system to perform wireless communication with each of the position detection apparatuses. The position indicator includes a controller connected to the wireless communication circuit and configured to perform communication control of the wireless communication circuit to switch roles of master and slave according to the number of position detection apparatuses connected at a same time.

### BACKGROUND

### TECHNICAL FIELD

The present disclosure relates to a position input system, a position indicator, and a communication method.

### DESCRIPTION OF THE RELATED ART

Input systems including an electronic pen (or stylus) that is a position indicator and an electronic device including a planar pen sensor are known in the field. A communication method has been proposed including transmitting and receiving data through a wireless communication method different than the communication method used for detecting the position indicated by the electronic pen.

Japanese Patent No. 6914267 discloses a pairing method including using information shared in communication in a relatively narrow communication range to determine the transmission source of data received through wireless communication in a relatively wide communication range.

Japanese Patent No. 6914267 illustrates only a network configuration in which a plurality of position indicators are connected to one position detection apparatus and includes no description on a network configuration opposite the network configuration. For example, there is still room for technical improvement in wireless communication using a master-slave system and/or a polling method when a plurality of position detection apparatuses are connected to one position indicator.

### BRIEF SUMMARY

The present disclosure has been made in view of the problem mentioned above, and an object of the present disclosure is to provide a position input system, a position indicator, and a communication method that can more efficiently execute wireless communication using at least a master-slave system when a plurality of position detection apparatuses are connected to one position indicator.

A first aspect of the present disclosure provides a position input system including a position indicator for indicating a position, and a plurality of position detection apparatuses that receive the indication by the position indicator, in which the position indicator includes a wireless communication circuit that uses a master-slave system to perform wireless communication with each of the position detection apparatuses, and a controller connected to the wireless communication circuit and configured to perform communication control of the wireless communication circuit to switch roles of master and slave according to the number of position detection apparatuses connected at the same time.

A second aspect of the present disclosure provides a position indicator used along with a plurality of position detection apparatuses that receive indication of a position, the position indicator including a wireless communication circuit that uses a master-slave system to perform wireless communication with each of the position detection apparatuses, and a controller connected to the wireless communication circuit and configured to perform communication control of the wireless communication circuit to switch roles of master and slave according to the number of position detection apparatuses connected at the same time.

A third aspect of the present disclosure provides a communication method using a position input system, the position input system including a position indicator for indicating a position, and a plurality of position detection apparatuses that receive the indication made by the position indicator, the communication method including using, by the position indicator, a master-slave system to perform wireless communication with each of the position detection apparatuses, and switching, by the position indicator or the position detection apparatuses, roles of master and slave according to the number of position detection apparatuses connected at the same time.

According to the present disclosure, the wireless communication using at least the master-slave system can be more efficiently executed when a plurality of position detection apparatuses are connected to one position indicator.

### BRIEF DESCRIPTION OF THE DRAWINGS

FIG. 1 depicts a configuration of a position input system in an embodiment of the present disclosure;

FIG. 2 is a schematic block diagram of an electronic pen and a tablet terminal illustrated in FIG. 1;

FIG. 3 depicts a connection state of an electronic pen and a tablet terminal in a comparative example;

FIG. 4 is a time chart illustrating an example of communication results in the comparative example of FIG. 3;

FIG. 5 is a flow chart illustrating a first action by the position input system of FIGS. 1 and 2;

FIG. 6 is a flow chart illustrating a second action by the position input system of FIGS. 1 and 2;

FIG. 7 depicts an example of an assignment rule of roles in the flow charts of FIGS. 5 and 6;

FIG. 8 depicts a connection state of the electronic pen and the tablet terminal in the embodiment;

FIG. 9 is a time chart illustrating an example of communication results in the embodiment of FIG. 7;

FIG. 10 is a detailed flow chart of the first action of FIG. 5;

FIG. 11 depicts a connection state before establishment of connection;

FIG. 12 depicts a connection state after the establishment of the connection; and

FIG. 13 depicts an example of a setting method of polling intervals.

### DETAILED DESCRIPTION

An embodiment of the present disclosure will be described below with reference to the attached drawings. To facilitate the understanding of the description, the same reference signs are provided as much as possible to the same constituent elements in the drawings, and the description will not be repeated. A word “unit” may be replaced with another word, such as a portion, a module, a device, or an element.

### Configuration of Position Input System 10

### System Configuration

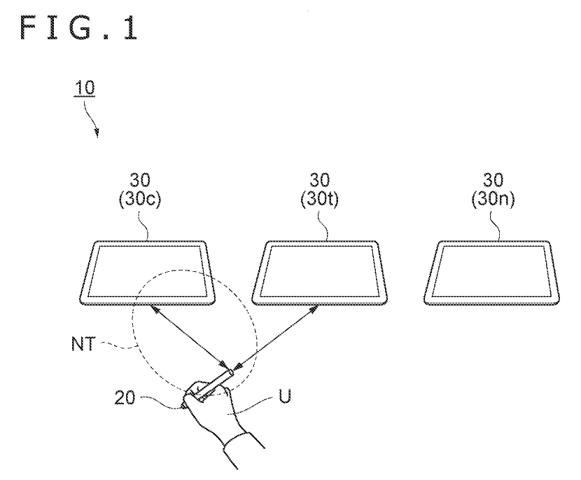

FIG. 1 depicts a configuration of a position input system 10 in an embodiment of the present disclosure. The position input system 10 can provide, for example, a “digital ink service” for handling handwritten content of a user U as digital data. The position input system 10 specifically includes one electronic pen 20 (corresponding to a “position indicator”) and a plurality of tablet terminals 30 (corresponding to “position detection apparatuses”) used along with the electronic pen 20.

The electronic pen 20 is a pen-type pointing device capable of one-way or two-way communication with the tablet terminals 30. In the embodiment, the electronic pen 20 is a stylus of active capacitive coupling type (AES). The electronic pen 20 and the tablet terminals 30 are capacitively coupled to each other.

The tablet terminal 30 is a position detection apparatus that receives indication of a position made by the electronic pen 20. Specifically, the tablet terminal 30 is a tablet computer that may or may not have a display function. Other than the tablet terminal 30, the position detection apparatus may be [1] a general-purpose computer, such as a smartphone, a personal computer, and a wearable device, or [2] a paper-like device specific to a pen detection function. The position detection apparatus may be [1] a device provided in a building (for example, home appliance, furniture, or equipment) or [2] a device as part of a building (for example, wall, floor, window, or pillar).

The electronic pen 20 and the tablet terminals 30 perform two-way digital wireless communication through a communication method different from that of the communication method for detecting the indicated position. Examples of digital wireless communication include Bluetooth (registered trademark), Bluetooth (registered trademark) Low Energy (BLE), or Ultra-Wide Band (UWB). The electronic pen 20 and the tablet terminals 30 establish a connection to construct a [1] one-to-one, [2] one-to-many, or [3] many-to-many small-scale network NT.

In the following description, the tablet terminals 30 will be distinctively expressed in some cases to explicitly illustrate the state of connection to the electronic pen 20. The tablet terminal 30 constructing the small-scale network NT with the electronic pen 20 will be referred to as a “connected terminal 30c.” The tablet terminal 30 trying to establish a connection to the electronic pen 20 will be referred to as a “target terminal 30t.” The tablet terminal 30 not constructing the small-scale network NT with the electronic pen 20 will be referred to as an “unconnected terminal 30n.”

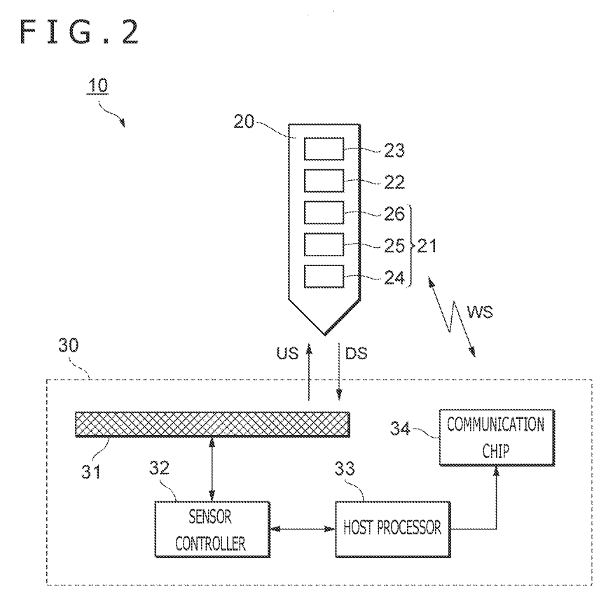

FIG. 2 is a schematic block diagram of the electronic pen 20 and the tablet terminal 30 illustrated in FIG. 1. The electronic pen 20 includes a pen controller 21 (corresponding to a “controller”), a communication chip 22 (corresponding to a “wireless communication circuit”), and a power module 23. The tablet terminal 30 includes a planar sensor 31, a sensor controller 32, a host processor 33, and a communication chip 34.

The pen controller 21 includes one or a plurality of circuit boards that control various actions of the electronic pen 20. The pen controller 21 specifically includes a reception circuit 24, a transmission circuit 25, and a micro control unit (hereinafter, MCU 26).

The reception circuit 24 is a circuit that receives an uplink signal US through a pen electrode (not illustrated) and then outputs the uplink signal US toward the MCU 26. Specifically, the reception circuit 24 includes an analog circuit including an amplification circuit and an Analog-Digital (AD) conversion circuit, and a digital circuit including a matched filter and a data restoration unit.

The transmission circuit 25 is a circuit that generates a downlink signal DS and then outputs the downlink signal DS toward the pen electrode (not illustrated). Specifically, the transmission circuit 25 includes an oscillation circuit that generates a carrier signal oscillating at a predetermined frequency, and a modulation circuit that uses data included in a control signal from the MCU 26 and modulates the carrier signal.

The MCU 26 is a control unit including a processor that can control various actions of the electronic pen 20. For example, the MCU 26 [1] controls the reception of the uplink signal US, [2] controls the transmission of the downlink signal DS, and [3] controls the transmission and reception of data through the communication chip 22.

The communication chip 22 is an integrated circuit that performs digital wireless communication with external apparatuses according to various wireless communication standards including Bluetooth (registered trademark), BLE, and UWB. This allows the electronic pen 20 to exchange various kinds of data with the tablet terminal 30 through the communication chip 22.

The power module 23 is a part that supplies drive power to electronic parts or electronic elements provided on the pen controller 21. The power module 23 includes, for example, a storage unit such as a battery and a capacitor; and a Power Management Integrated Circuit (PMIC) that manages the power of the storage unit.

The planar sensor 31 of the tablet terminal 30 is a touch sensor of a capacitance type including a plurality of sensor electrodes arranged in a planar shape. The planar sensor 31 includes, for example, a plurality of X-line electrodes that detect the position on the X-axis of the sensor coordinate system and a plurality of Y-line electrodes that detect the position on the Y-axis. Each line electrode may include a transparent conductive material containing Indium Tin Oxide (ITO) or may include a wire mesh sensor. Note that the planar sensor 31 may be a sensor of a self-capacitance type including block-shaped electrodes arranged in a two-dimensional grid, instead of the sensor of a mutual capacitance type.

The sensor controller 32 is a circuit board connected to the planar sensor 31 and configured to control the communication with the electronic pen 20 through the planar sensor 31. Specifically, the sensor controller 32 transmits the uplink signal US toward the electronic pen 20 and receives the downlink signal DS from the electronic pen 20 to detect the indicated position of the electronic pen 20. In this way, the sensor controller 32 executes a “pen detection function” of detecting the state of the electronic pen 20. When the planar sensor 31 is a touch sensor of a capacitance type, the sensor controller 32 further executes a “touch detection function” of detecting whether there is a touch by a passive pointer, such as a finger of the user U, and the position of the touch.

The host processor 33 includes an arithmetic processing unit including a Central Processing Unit (CPU), a Graphics Processing Unit (GPU), or a Micro-Processing Unit (MPU). The host processor 33 can read and execute a program stored in an unillustrated memory to execute various functions including, for example, generation of digital ink and control of transmission and reception of data.

As with the communication chip 22, the communication chip 34 is an integrated circuit that performs digital wireless communication with external apparatuses according to various communication standards including Bluetooth (registered trademark), BLE, and UWB. This allows the tablet terminal 30 to exchange various kinds of data with the electronic pen 20 through the communication chip 34.

A “master-slave system” for assigning a role of a controlling side (hereinafter, referred to as the “master”) to one device and assigning a role of a controlled side (hereinafter, referred to as the “slave”) to the remaining devices is used when a plurality of devices work in cooperation with each other in the wireless communication. The names master/slave are not limited to these, and the names may be primary/secondary, primary/replica, parent/child, or manager/worker. In the case of, for example, BLE, the master corresponds to the “center,” and the slave corresponds to the “peripheral.”

A “polling method” of sequentially and periodically sending inquiries to a plurality of devices and transmitting, receiving, or processing the data when a certain condition is satisfied may also be used in the wireless communication. In the case of the wireless communication combined with the master-slave system, the master device transmits a polling signal to the slave device, and the slave device transmits a response signal of the polling signal to the master device.

### Actions of Position Input System 10

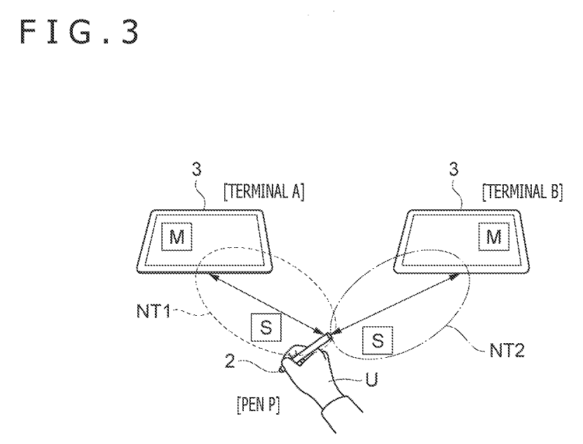

The position input system 10 in the embodiment is configured as described above. Next, actions of the position input system 10 will be described with reference to FIGS. 3 through 12.

### Description of Comparative Example

FIG. 3 depicts a connection state of an electronic pen 2 and tablet terminals 3 in a comparative example. A character “M” surrounded by a rectangular frame represents a state in which the device is assigned the role of “master.” A character “S” surrounded by a rectangular frame represents a state in which the device is assigned the role of “slave.” This similarly applies to FIGS. 8,11, and 12 described later.

First, the electronic pen 2 (hereinafter, also referred to as a “pen P”) and a first tablet terminal 3 (hereinafter, also referred to as a “terminal A”) are connected through a small-scale network NT1. The role of master is assigned to the terminal A, and the role of slave is assigned to the pen P. Subsequently, the electronic pen 2 and a second tablet terminal 3 (hereinafter, also referred to as a “terminal B”) are connected through another small-scale network NT2. The role of master is assigned to the terminal B, and the role of slave is assigned to the pen P. A case in which the pen P and the two terminals A and B use the polling method to exchange data will be illustrated below.

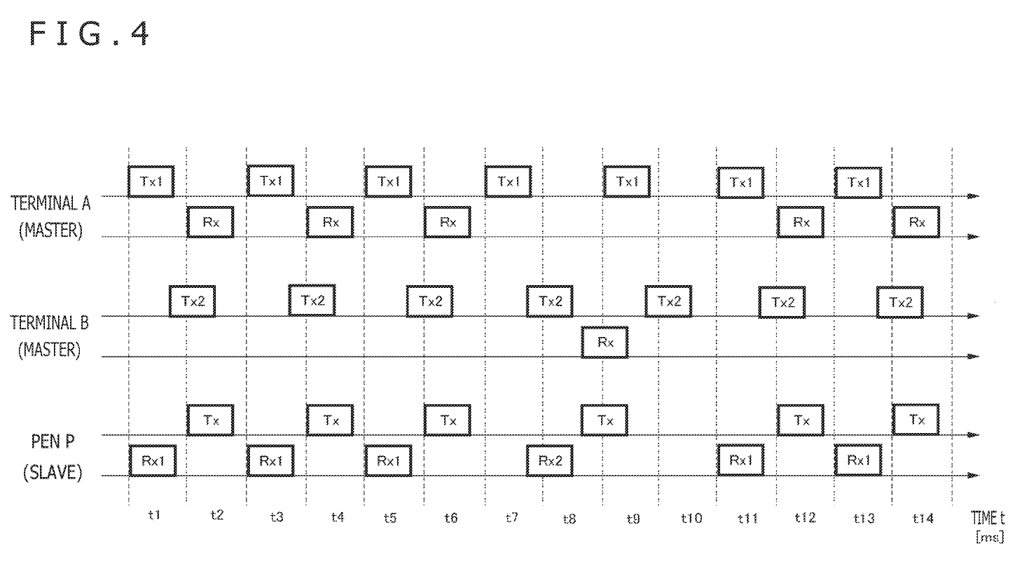

FIG. 4 is a time chart illustrating an example of communication results in the comparative example of FIG. 3. In the example of FIG. 4, the timing related to the polling of the terminal A and the pen P is divided into 14 time zones t1 through t14. The terminal A as the “master” transmits polling packets Tx1 applied to the small-scale network NT1 in odd-numbered time zones and receives response packets Tx from the pen P in even-numbered time zones. The pen P as the “slave” receives the polling packets Tx1 in the odd-numbered time zones and transmits packets (hereinafter, response packets Tx) in response to the polling packets Tx1 in the even-numbered time zones. The pen P can periodically supply pen information (such as pen pressure and remaining battery) held by the pen P to the terminal A through the periodical polling.

In the example of FIG. 4, the polling is further performed between the terminal B and the pen P. The terminal B as the “master” transmits polling packets Tx2 applied to the small-scale network NT2 and receives response packets Tx from the pen P. The pen P as the “slave” receives the polling packets Tx2 and transmits response packets Tx in response to the polling packets Tx2.

A case in which, for example, polling intervals set for the small-scale networks NT1 and NT2 are different will be illustrated. The pen P can receive one of the polling packets Tx1 and Tx2 in each time zone in which there is no collision of two types of polling. In the example of FIG. 4, the terminal A can acquire the pen information held by the pen P, through the reception of the response packets Tx in the time zones t1, t3, t5, t11, and t13 in which the pen P receives the polling packets Tx1 (time zones t2, t4, t6, t12, and t14).

However, in a time zone in which there is a collision of two types of polling, the preceding polling becomes effective, and the following polling becomes ineffective. In the example of FIG. 4, the terminal A cannot acquire the pen information held by the pen P in the time zones t7 and t9 in which the pen P does not receive the polling packets Tx1 (time zones t8 and t10). In contrast, the terminal B can acquire the pen information held by the pen P, through the reception of the response packets Tx in the time zones t7 and t9 in which the pen P receives the polling packets Tx2 (time zones t8 and t10).

### Actions of Pen Controller 21

In this way, the data may not be exchanged at the timing of the collision of polling when the role of master is assigned to a plurality of devices in the wireless communication using the combination of the master-slave system and the polling method. Hence, the position input system 10 in the embodiment performs communication control for more efficiently performing the wireless communication using the master-slave system when a plurality of tablet terminals 30 are connected to one electronic pen 20.

The communication control by the pen controller 21 (more specifically, the MCU 26) will be specifically described below. Information processing related to the communication control includes [1] a detection process of a connection event, [2] a mutual recognition process of connected devices, [3] an assignment process of roles, [4] an establishment/disconnection process of connection, or [5] a polling process.

[1] The pen controller 21 executes the “detection process” of detecting an event related to the connection to the tablet terminal 30 (hereinafter, a connection event). The connection event is classified into a “connection start event” for starting the connection and a “connection end event” for ending the connection. Examples of the connection event include [1] reception of operation of a hardware switch or a software switch provided on the tablet terminal 30 and [2] detection of approach of the tablet terminal 30 through short-range wireless communication (for example, near field communication (NFC)).

[2] The pen controller 21 executes the “recognition process” of recognizing the tablet terminal 30 specified through the detection of the connection event. The recognition process is performed through an advertisement and a scan defined in the Generic Access Profile (GAP) in the example of BLE. The “advertisement” is a function of a peripheral device (corresponding to the “slave device”) transmitting a packet through an advertising channel to transmit information of the peripheral device itself. The “scan” is a function in which a central device (corresponding to the “master device”) enters the reception state to acquire information of the nearby peripheral device.

[3] The pen controller 21 executes the “assignment process” of assigning a role in communication (hereinafter, also simply referred to as a “role”) to the electronic pen 20 or the tablet terminal 30. For example, the pen controller 21 assigns the role of master or slave according to the number of tablet terminals 30 connected at the same time.

When the number of connected tablet terminals 30 is one, the pen controller 21 constructs a one-to-one network including, for example, the electronic pen 20 that is assigned the role of slave and the tablet terminal 30 that is assigned the role of master. Instead of this, the pen controller 21 may construct a one-to-one network including the electronic pen 20 that is assigned the role of master and the tablet terminal 30 that is assigned the role of slave.

When the number of connected tablet terminals 30 is equal to or greater than two, the pen controller 21 constructs a one-to-many network including the electronic pen 20 that is assigned the role of master and a group of tablet terminals 30 each being assigned the role of slave. Here, the roles are switched [1] if the electronic pen 20 is assigned the role of slave when the number of connected tablet terminals 30 increases from one to two or [2] if the electronic pen 20 is assigned the role of master when the number of connected tablet terminals 30 decreases from two to one.

It is assumed that a one-to-one network including one of the plurality of tablet terminals 30 (hereinafter, also referred to as the “first detection apparatus”) and the electronic pen 20 is constructed. In this case, when a connection between another one of the plurality of tablet terminals 30 (hereinafter, also referred to as the “second detection apparatus”) and the electronic pen 20 is established, the pen controller 21 constructs a one-to-many network including the electronic pen 20, the first detection apparatus, and the second detection apparatus. Here, the construction method of the one-to-many network varies according to the role of the electronic pen 20 in the one-to-one network.

First, when the first detection apparatus is assigned the role of master and the electronic pen 20 is assigned the role of slave, the pen controller 21 ends the connection between the first detection apparatus and the electronic pen 20 and then constructs a one-to-many network including the electronic pen 20 that is assigned the role of master and the first detection apparatus and the second detection apparatus each being assigned the role of slave.

Second, when the electronic pen 20 is assigned the role of master and the first detection apparatus is assigned the role of slave, the pen controller 21 newly constructs a one-to-many network by adding the second detection apparatus that is assigned the role of slave to the one-to-one network.

It is assumed that a one-to-many network is constructed including the electronic pen 20, which is assigned the role of master, and the first and second detection apparatuses, which are two tablet terminals 30 each being assigned the role of slave. In this case, when the connection between the second detection apparatus and the electronic pen 20 is disconnected, the pen controller 21 further ends the connection between the first detection apparatus and the electronic pen 20 and then constructs a one-to-one network including the electronic pen 20 that is assigned the role of slave and the first detection apparatus that is assigned the role of master.

[4] The pen controller 21 executes the “connection process” of establishing the connection to one or more tablet terminals 30 or the “disconnection process” of disconnecting the connection to one or more tablet terminals 30 according to a predetermined communication rule.

[5] The pen controller 21 executes the “polling process” of using the polling method to exchange data with the tablet terminal 30. When the electronic pen 20 is the “master,” the pen controller 21 transmits at least one type of polling signal to the tablet terminal 30 as the “slave” at predetermined polling intervals and in time series. When the electronic pen 20 is the “slave,” the pen controller 21 transmits the response signal for the received polling signal to the tablet terminal 30 as the “master.”

The polling interval may be a fixed value or may be a variable value. When the one-to-many network is constructed, the values of the polling intervals may be the same regardless of the plurality of tablet terminals 30 that are assigned the roles of slaves, or the values may be different according to the tablet terminals 30. For example, the polling intervals for the tablet terminal 30 in a used state may be shorter than the polling intervals for the tablet terminal 30 in an unused state.

The state of the tablet terminal 30 may be classified into, for example, a “used state” and an “unused state.” The used state includes an “in use” state in which the tablet terminal 30 is currently used and a “usable” state in which the tablet terminal 30 is likely to be immediately used. The unused state includes an “unused” state in which the tablet terminal 30 is unlikely to be immediately used. The state is classified according to, for example, [1] whether there is a pen pressure applied to the electronic pen 20 (on/off state), [2] the reception strength of the downlink signal DS, [3] the action mode of the tablet terminal 30, or [4] a combination of the quantities of the states.

For example, when the pen pressure of the electronic pen 20 is in an “ON state,” the pen controller 21 may determine that the terminal with the largest reception strength among the two or more tablet terminals 30 belonging to the group is “in use.” When the pen pressure of the electronic pen 20 is in an “OFF state,” the pen controller 21 may determine that the terminal with the reception strength exceeding a threshold among the two or more tablet terminals 30 belonging to the group is “usable” and determine that the terminal with the reception strength equal to or smaller than the threshold is “unused.” The pen controller 21 may determine that the terminal in an action mode (for example, a sleep mode, a standby mode, or a power saving mode) executed while waiting or during the fallback among the two or more tablet terminals 30 belonging to the group is “unused.”

The polling signal or the response signal may include various types of information held or generated by the device as a transmission source. For example, the electronic pen 20 as the “master” transmits the polling signal including the pen information of the electronic pen 20 itself to the tablet terminal 30 as the “slave.” Alternatively, the electronic pen 20 as the “slave” transmits the response signal including the pen information of the electronic pen 20 itself to the tablet terminal 30 as the “master.” Examples of the pen information include identification information of the electronic pen 20, whether there is a pen pressure, the magnitude of the pen pressure, and the remaining battery.

### Description of Role Switching Actions

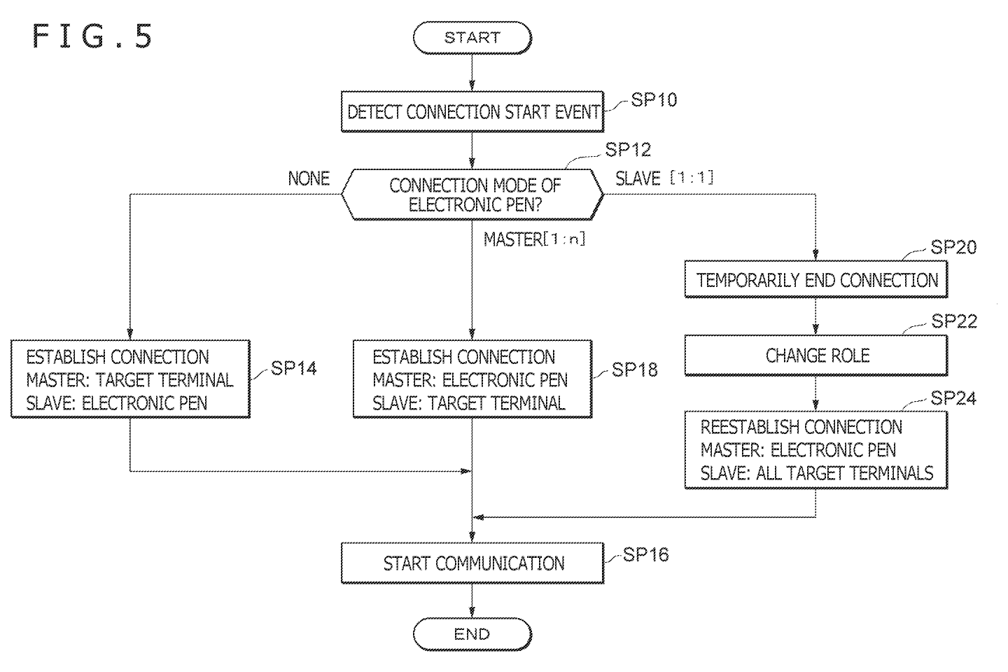

FIG. 5 is a flow chart illustrating a first action by the position input system 10 of FIGS. 1 and 2. The “first action” is related to the communication control of the electronic pen 20 in starting the wireless communication with the target terminal 30t.

In step SP10, the electronic pen 20 (more specifically, the pen controller 21) detects the event (that is, the connection start event) for starting to connect to the tablet terminal 30. The target terminal 30t is specified through the detection.

In step SP12, the pen controller 21, following the detection performed in step SP10, checks the connection mode of the electronic pen 20. If there is no connected terminal 30c at the moment (step SP12: none), the pen controller 21 proceeds to step SP14.

In step SP14, the pen controller 21 establishes the connection to the target terminal 30t and proceeds to the following step SP16. Here, the target terminal 30t is assigned the role of “master,” and the electronic pen 20 is assigned the role of “slave.” The target terminal 30t transitions to the connected terminal 30c through the establishment of the connection.

In step SP16, the pen controller 21 uses the polling method to start the wireless communication with one connected terminal 30c.

In step SP12, if the electronic pen 20 is connected to n (n≥1) or more connected terminals 30c at the same time and is assigned the role of “master” (step SP12: master [1:n]), the pen controller 21 proceeds to step SP18.

In step SP18, the pen controller 21 establishes the connection to the target terminal 30t and then proceeds to step SP16. Here, the electronic pen 20 is assigned the role of “master,” and each target terminal 30t is assigned the role of “slave.” Each target terminal 30t transitions to the connected terminal 30c through the establishment of the connection.

In step SP16, the pen controller 21 uses the polling method to start the wireless communication with (n+1) connected terminals 30c.

In step SP12, if the electronic pen 20 is connected to one connected terminal 30c and is assigned the role of “slave” (step SP12: slave [1:1]), the pen controller 21 proceeds to step SP20.

In step SP20, the pen controller 21 temporarily disconnects all of the connections established at the moment. The connected terminal 30c transitions to the target terminal 30t through the disconnection.

In step SP22, the pen controller 21 changes the role of the electronic pen 20 from the “slave” to the “master.”

In step SP24, the pen controller 21 reestablishes the connection to the two target terminals 30t and then proceeds to step SP16. Here, the electronic pen 20 is assigned the role of “master,” and the two target terminals 30t are each assigned the role of “slave.” The target terminals 30t transition to the connected terminals 30c through the establishment of the connection.

In step SP16, the pen controller 21 uses the polling method to start the wireless communication with the two connected terminals 30c. In this way, the electronic pen 20 performs the wireless communication with the tablet terminals 30.

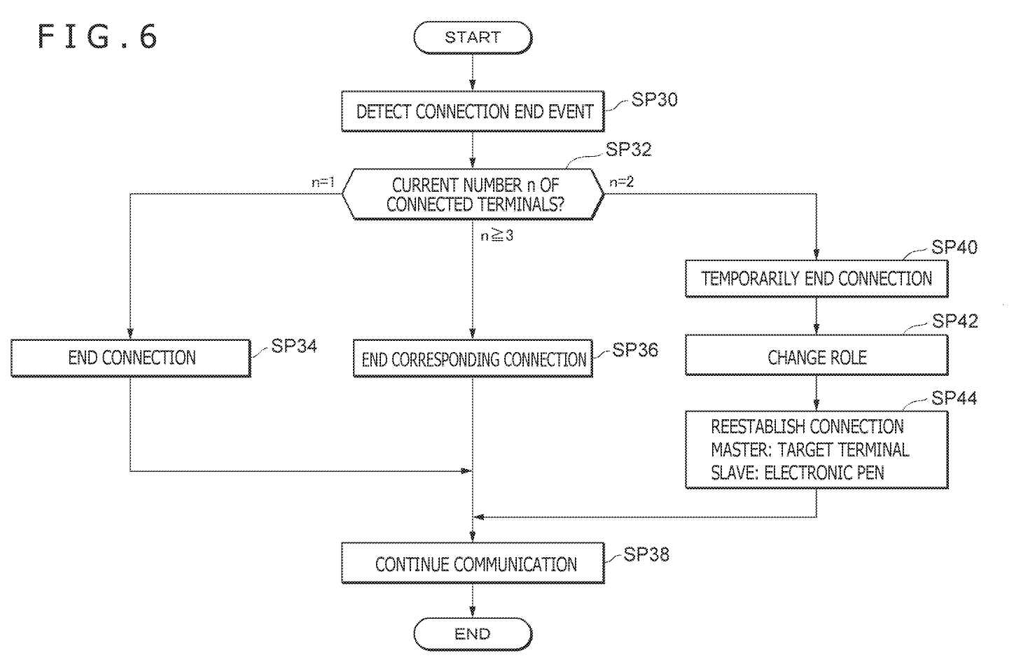

FIG. 6 is a flow chart illustrating a second action by the position input system 10 of FIGS. 1 and 2. The “second action” is related to the communication control of the electronic pen 20 in ending the wireless communication with the connected terminal 30c.

In step SP30, the electronic pen 20 (more specifically, the pen controller 21) detects the event (that is, the connection end event) for ending the connection to the tablet terminal 30. The target terminal 30t is specified through the detection.

In step SP32, the pen controller 21, following the detection performed in step SP30, checks the number (n) of connected terminals 30c at the moment. If the number of connected terminals 30c is one (step SP12: n=1), the pen controller 21 proceeds to step SP34.

In step SP34, the pen controller 21 ends the connection to the target terminal 30t and ends the wireless communication with the tablet terminal 30. As a result, the electronic pen 20 ends the execution of the flow chart of FIG. 6.

In step SP32, if the number of connected terminals 30c is equal to or greater than three (step SP32: n≥3), the pen controller 21 proceeds to step SP36.

In step SP36, the pen controller 21 disconnects the connection to the target terminal 30t. The target terminal 30t transitions to the unconnected terminal 30n through the disconnection.

In step SP38, the pen controller 21 continues to use the polling method to perform the wireless communication with the remaining (n-1) connected terminals 30c.

In step SP32, if the number of connected terminals 30c is two (step SP32: n=2), the pen controller 21 proceeds to step SP40.

In step SP40, the pen controller 21 temporarily disconnects all of the connections established at the moment. Through the disconnection, the target terminal 30t transitions to the unconnected terminal 30n, and the connected terminal 30c transitions to the target terminal 30t.

In step SP42, the pen controller 21 changes the role of the electronic pen 20 from the “master” to the “slave.”

In step SP44, the pen controller 21 reestablishes the connection to one target terminal 30t and proceeds to step SP38. Here, the one target terminal 30t is assigned the role of “master,” and the electronic pen 20 is assigned the role of “slave.” The target terminal 30t transitions to the connected terminal 30c through the establishment of the connection.

In step SP38, the pen controller 21 continues to use the polling method to perform the wireless communication with the one remaining connected terminal 30c.

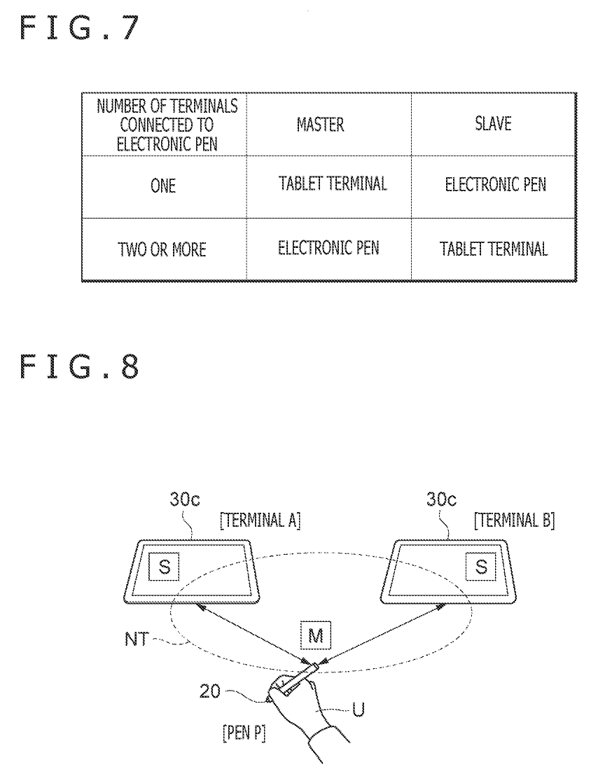

FIG. 7 depicts an example of an assignment rule of the roles in the flow charts of FIGS. 5 and 6. More specifically, FIG. 7 is a table illustrating a relation between the number of tablet terminals 30 connected to the electronic pen 20 and the role assigned to each device. If the number of connected tablet terminals 30 is one, the tablet terminal 30 is assigned the role of “master,” and the electronic pen 20 is assigned the role of “slave.” If the number of connected tablet terminals 30 is equal to or greater than two, the electronic pen 20 is assigned the role of “master,” and each of the tablet terminals 30 is assigned the role of “slave.”

### Effects of Role Switching Actions

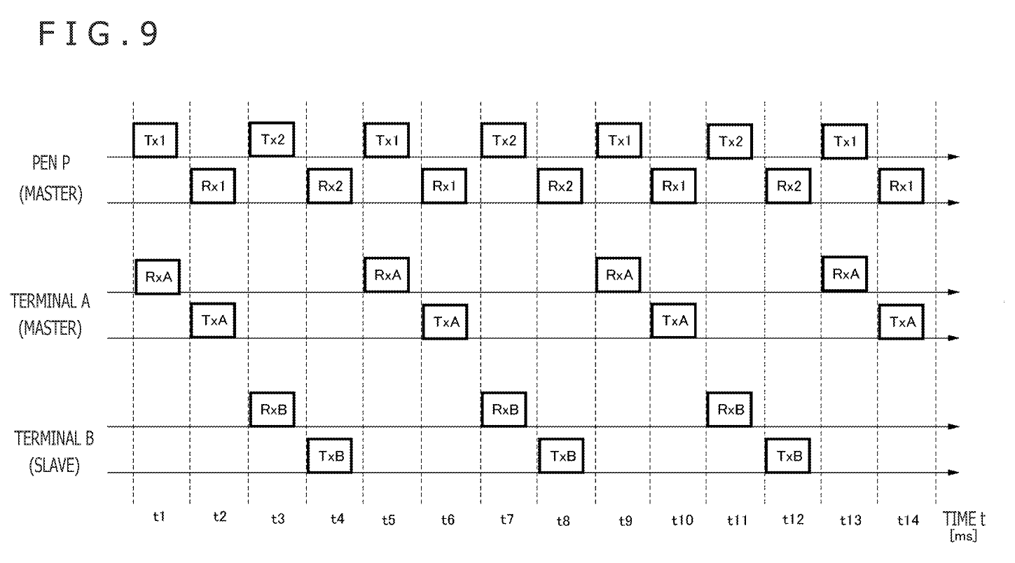

Effects of the role switching actions described with reference to FIGS. 5 through 7 will now be described with reference to FIGS. 8 and 9.

When the number of connected tablet terminals 30 is one, the electronic pen 20 transmits the response signal including the pen information in response to the polling signal from the tablet terminal 30. Adopting the on-demand transmission reduces unnecessary transmission opportunities for the electronic pen 20, thus suppressing the power consumption of the electronic pen 20.

When the number of connected tablet terminals 30 is equal to or greater than two, the electronic pen 20 transmits the polling signals including the pen information to the two or more tablet terminals 30 in time series. Adopting the time-series transmission managed by the electronic pen 20 can prevent the collision of polling, thereby suppressing the loss of supply opportunities of the pen information from the electronic pen 20.

FIG. 8 depicts a connection state of the electronic pen 20 and the tablet terminals 30 in the embodiment. As in the case of FIG. 3, the electronic pen 20 (hereinafter, also referred to as the “pen P”) and a first tablet terminal 30 (hereinafter, also referred to as the “terminal A”) are connected. The terminal A is assigned the role of master, and the pen P is assigned the role of slave. Subsequently, the pen P and a second tablet terminal 30 (hereinafter, also referred to as the “terminal B”) are connected, and the pen P and the terminals A and B are connected through one small-scale network NT. The pen P is assigned the role of master, and the terminals A and B are each assigned the role of slave. A case in which the polling method is used to exchange data between the pen P and the two terminals A and B will be illustrated.

FIG. 9 is a time chart illustrating an example of communication results in the embodiment of FIG. 8. In the example of FIG. 9, the timing related to the polling of the terminal A and the pen P is divided into 14 time zones t1 through t14 as in the case of FIG. 4. The pen P as the “master” alternately transmits the polling packets Tx1 and Tx2 applied to the small-scale network NT in the odd-numbered time zones and alternately receives the response packets Tx from the terminals A and B in the even-numbered time zones. The terminals A and B as the “slaves” alternately receive the polling packets Tx1 and Tx2 in the odd-numbered time zones and alternately transmit packets (that is, response packets TxA and TxB) in response to the polling packets Tx1 and Tx2 in the even-numbered time zones. The pen P can periodically supply the pen information held by the pen P itself to the terminals A and B through the periodical polling.

In the example of FIG. 9, the pen P performs the time-series transmission of polling to prevent the collision of two types of polling. In this way, the terminal A can acquire the pen information held by the pen P, through the reception of the polling packets Tx1 (time zones t1, t5, t9, and t13). The terminal B can acquire the pen information held by the pen P, through the reception of the polling packets Tx1 (time zones t3, t7, and t11).

In addition, the terminals A and B can periodically supply the terminal information (such as the type of action mode and the pen detection result) held by the terminals A and B themselves to the pen P. Specifically, the pen P can acquire the terminal information held by the terminal A, through the reception of the response packets TxA (time zones t2, t6, t10, and t14). The pen P can acquire the terminal information held by the terminal B, through the reception of the response packets TxB (time zones t4, t8, and t12).

### Specific Example of Role Switching Actions

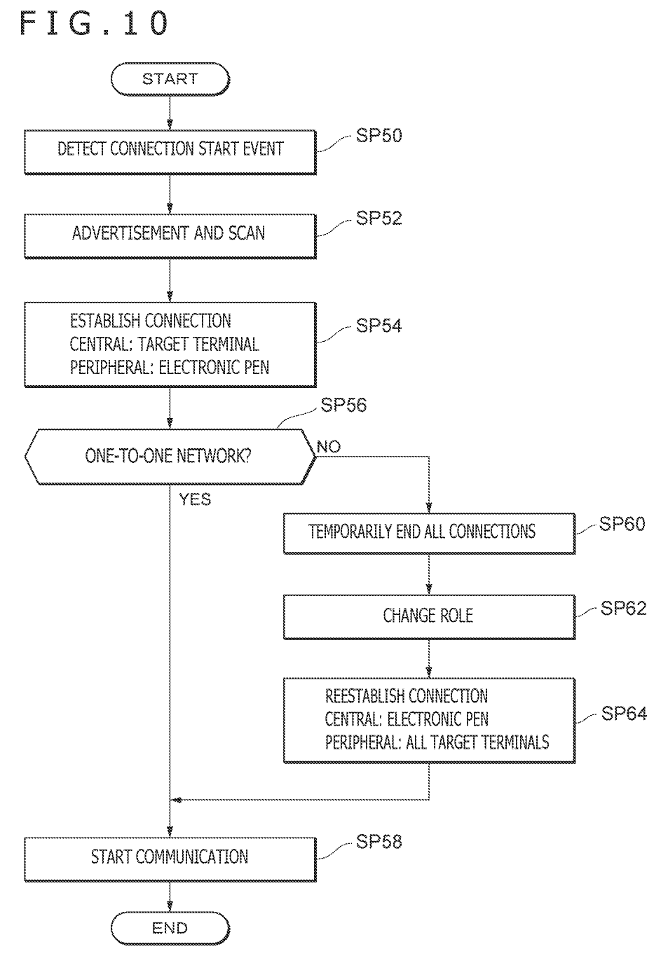

A specific example of the role switching actions will next be described with reference to FIGS. 10 through 13.

FIG. 10 is a detailed flow chart of the first action of FIG. 5. In a case illustrated here, BLE is used as the standard of wireless communication.

In step SP50, the electronic pen 20 detects the connection start event when the unconnected terminal 30n receives a request operation performed by the user U.

In step SP52, the electronic pen 20 and the unconnected terminal 30n, following the detection performed in step SP50, execute the advertisement managed by the peripheral (corresponding to the “slave”) or the scan managed by the central (corresponding to the “master”) for mutual recognition of the connected devices. As a result, the unconnected terminal 30n transitions to the target terminal 30t.

In step SP54, the electronic pen 20 establishes the connection to the tablet terminal 30 (that is, the target terminal 30t) recognized in step SP52 and then proceeds to the following step SP56. Here, the electronic pen 20 is assigned the role of “peripheral,” and the target terminal 30t is assigned the role of “central.” The target terminal 30t transitions to the connected terminal 30c through the establishment of the connection.

In step SP56, the electronic pen 20 checks whether the one-to-one network with a single terminal is constructed after the execution of step SP54. If the one-to-one network with a single terminal is constructed (step SP56: YES), the electronic pen 20 proceeds to the following step SP58.

In step SP58, the electronic pen 20 uses the polling method to start the wireless communication with the one connected terminal 30c connected in step SP54.

On the other hand, if the one-to-one network with a single terminal is not constructed in step SP56 (step SP56: NO), the electronic pen 20 proceeds to step SP60.

In step SP60, the electronic pen 20 temporarily disconnects and ends all of the connections established at the moment. The one connected terminal 30c temporarily transitions to the target terminal 30t through the disconnection.

In step SP62, the electronic pen 20 changes its role from “peripheral” to “central.” As a result, the electronic pen 20 is assigned the role of “central,” and the two tablet terminals 30 (target terminals 30t) are each assigned the role of “peripheral.”

In step SP64, the electronic pen 20 reestablishes the connection to the two target terminals 30t and then proceeds to step SP58. Here, the electronic pen 20 is assigned the role of “central,” and the two target terminals 30t are each assigned the role of “peripheral.” The target terminals 30t transition to the connected terminal 30c through the reestablishment of the connection.

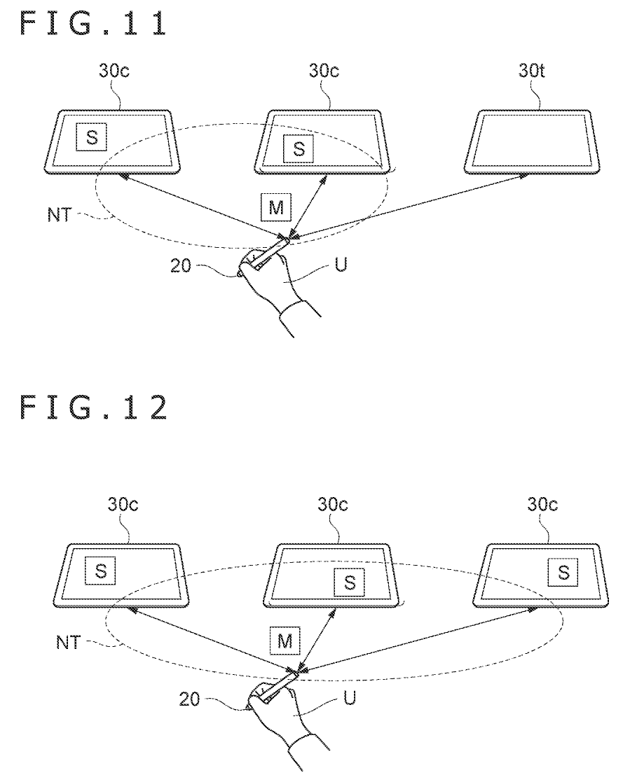

FIG. 11 depicts the connection state before the establishment of the connection. Three tablet terminals 30 are lined up and arranged in the horizontal direction in the example of FIG. 11. The tablet terminals 30 on the left and at the center (that is, connected terminals 30c) are connected to the electronic pen 20 through one small-scale network NT. The electronic pen 20 is assigned the role of “central” (master), and the connected terminals 30c are each assigned the role of “peripheral” (slave). Note that the tablet terminal 30 on the right corresponds to the device trying to establish the connection to the electronic pen 20 (that is, the target terminal 30t).

FIG. 12 depicts the connection state after the establishment of the connection. More specifically, FIG. 12 illustrates a state in which the target terminal 30t of FIG. 11 is connected to the electronic pen 20. All of the three tablet terminals 30 (that is, the connected terminals 30c) are connected to the electronic pen 20 through one small-scale network NT. Here, the electronic pen 20 is assigned the role of “central” (master), and the connected terminals 30c are each assigned the role of “peripheral” (slave).

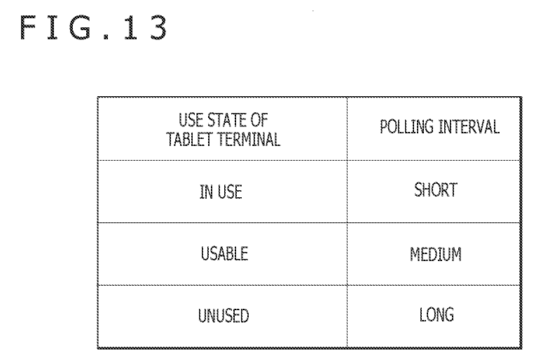

FIG. 13 depicts an example of a setting method of the polling interval. More specifically, FIG. 13 is a table illustrating a relation between the use state of the tablet terminal 30 and the polling interval. When the tablet terminal 30 is “in use,” the polling interval is set to a relatively short period of time. When the tablet terminal 30 is “usable,” the polling interval is set to a medium period of time. When the tablet terminal 30 is “unused,” the polling interval is set to a relatively long period of time.

### Conclusion of Embodiment

As described above, the position input system 10 in the embodiment includes the position indicator (here, the electronic pen 20) for indicating the position, and the plurality of position detection apparatuses (here, the tablet terminals 30) that receive the indication made by the electronic pen 20. The electronic pen 20 includes a wireless communication circuit (here, the communication chip 22) that uses the master-slave system to perform the wireless communication with each of the tablet terminals 30, and the controller (here, the pen controller 21) connected to the communication chip 22. The controller is configured to perform the communication control of the communication chip 22 to switch the roles of master and slave according to the number of tablet terminals 30 connected at the same time.

The communication method using the position input system 10 in the embodiment includes the step of using, by the electronic pen 20, the master-slave system to perform the wireless communication with each of the tablet terminals 30 (SP16, SP38, or SP58); and the step of switching, by the electronic pen 20 or the tablet terminals 30, the roles of master and slave according to the number of tablet terminals 30 connected at the same time (SP22, SP42, or SP62).

According to the configuration, the wireless communication using at least the master-slave system can be more efficiently executed through the dynamic switch of the roles according to the number of connected tablet terminals 30 when a plurality of tablet terminals 30 are connected to one electronic pen 20.

The wireless communication may be the communication using the polling method in combination with the master-slave system. This allows easy handling of the collision of polling.

The pen controller 21 may perform the communication control to construct the one-to-one network including the electronic pen 20 that is assigned the role of slave and the tablet terminal 30 that is assigned the role of master when the number of connected tablet terminals 30 is one. Adopting the on-demand transmission reduces unnecessary transmission opportunities for the electronic pen 20, thus suppressing the power consumption of the electronic pen 20.

The pen controller 21 may perform the communication control to construct the one-to-many network including the electronic pen 20 that is assigned the role of master and the group of tablet terminals 30 each being assigned the role of slave when the number of connected tablet terminals 30 is equal to or greater than two. Adopting the time-series transmission managed by the electronic pen 20 can prevent the collision of polling, thereby suppressing the loss of supply opportunities of the pen information from the electronic pen 20.

Under the condition that the one-to-one network is constructed including the first detection apparatus that is one of the plurality of tablet terminals 30 and the electronic pen 20, the pen controller 21 may perform the communication control to construct the connection between the second detection apparatus, which is another one of the plurality of tablet terminals 30, and the electronic pen 20 when the one-to-many network is to be established including the electronic pen 20, the first detection apparatus, and the second detection apparatus., In this way, the small-scale network NT can be more smoothly constructed when the number of connected tablet terminals 30 is shifted from one to two.

When the first detection apparatus is assigned the role of master and the electronic pen 20 is assigned the role of slave, the pen controller 21 may perform the communication control to end the connection between the first detection apparatus and the electronic pen 20 and then construct the one-to-many network including the electronic pen 20 that is assigned the role of master and the first detection apparatus and the second detection apparatus each being assigned the role of slave. In this way, if the electronic pen 20 is assigned the role of slave, the small-scale network NT can be more smoothly constructed when the number of connected tablet terminals 30 is shifted from one to two.

When the electronic pen 20 is assigned the role of master and the first detection apparatus is assigned the role of slave, the pen controller 21 may perform the communication control to add the second detection apparatus that is assigned the role of slave to the one-to-one network to newly construct the one-to-many network. In this way, if the electronic pen 20 is assigned the role of master, the small-scale network NT can be more smoothly constructed when the number of tablet terminals 30 is shifted from one to two.

Under the condition that the one-to-many network including the electronic pen 20, assigned the role of master, and the first detection apparatus and the second detection apparatus, each being assigned the role of slave, is constructed, when the connection between the second detection apparatus and the electronic pen 20 is to be ended, the pen controller 21 may perform the communication control to further end the connection between the first detection apparatus and the electronic pen 20 and then construct the one-to-one network including the electronic pen 20, assigned the role of slave, and the first detection apparatus, assigned the role of master. In this way, if the electronic pen 20 is assigned the role of master, the small-scale network NT can be more smoothly constructed when the number of connected tablet terminals 30 is shifted from two to one.

The pen controller 21 may classify the states of the tablet terminals 30 belonging to the group included in the one-to-many network into the used state and the unused state and perform the communication control to make the polling intervals for the tablet terminals 30 in the used state shorter than the polling intervals for the tablet terminals 30 in the unused state. In this way, the tablet terminal 30 that is more likely to be used can perform the polling at a higher frequency.

The position indicator may be the electronic pen 20 that can measure the pen pressure applied to the pen tip. The electronic pen 20 may transmit the polling signal including the pen pressure information related to the pen pressure to each of the tablet terminals 30, when being assigned the role of master. In this way, each of the tablet terminals 30 can acquire the pen pressure information of the electronic pen 20 in a timely manner.

### Modifications

Note that the present disclosure is not limited to the described embodiment, and it is obvious that the present disclosure can freely be changed without departing from the scope of the disclosure. In addition, the configurations may be combined as desired, as long as there is no technical contradiction. Furthermore, the order of executing or whether to execute the steps included in the flow charts may be changed as long as there is no technical contradiction.

Although the electronic pen 20 takes charge of the communication control in the example described in the embodiment, the subject of controlling the wireless communication is not limited to the electronic pen 20. Specifically, the tablet terminal 30 may take charge of the communication control, or the electronic pen 20 and the tablet terminal 30 may cooperate to perform the communication control. For example, when the tablet terminal 30 is the subject of controlling the wireless communication, the host processor 33 (FIG. 2) manages the function of the “controller,” and the communication chip 34 (FIG. 2) manages the function of the “wireless communication circuit.”

Although the pen-type electronic pen 20 is illustrated in the example described in the embodiment, the form of the position indicator is not limited to the pen type. Although the electronic pen 20 is a stylus of AES in the example described above, the electronic pen 20 may be a stylus of an electromagnetic induction type (EMR) instead of this. In the case of this device configuration, a planar sensor (or digitizer) including a plurality of loop coils is provided on the tablet terminal 30, and a reception circuit that receives a magnetic field signal generated by the planar sensor is provided on the electronic pen 20.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A position input system comprising:
a position indicator for indicating a position; and
a plurality of position detection apparatuses that receive the indication made by the position indicator, wherein
the position indicator includes
a wireless communication circuit that uses a master-slave system to perform wireless communication with each of the position detection apparatuses, and
a controller connected to the wireless communication circuit and configured to perform communication control of the wireless communication circuit to switch roles of master and slave according to the number of the position detection apparatuses connected at a same time.

2. The position input system according toclaim 1, wherein
the wireless communication is communication using a polling method in combination with the master-slave system.

3. The position input system according toclaim 2, wherein
the controller
performs the communication control to construct a one-to-one network including the position indicator that is assigned the role of slave and the position detection apparatus that is assigned the role of master, when the number of the connected position detection apparatuses is one, and
performs the communication control to construct a one-to-many network including the position indicator that is assigned the role of master and a group of the position detection apparatuses each being assigned the role of slave, when the number of the connected position detection apparatuses is equal to or greater than two.

4. The position input system according toclaim 3, wherein,
under a condition that the one-to-one network including a first detection apparatus that is one of the plurality of position detection apparatuses and the position indicator is constructed,
when a connection between a second detection apparatus that is another one of the plurality of position detection apparatuses and the position indicator is to be established, the controller performs the communication control to construct the one-to-many network including the position indicator, the first detection apparatus, and the second detection apparatus.

5. The position input system according toclaim 4, wherein,
when the first detection apparatus is assigned the role of master and the position indicator is assigned the role of slave,
the controller performs the communication control to end the connection between the first detection apparatus and the position indicator and then construct the one-to-many network including the position indicator that is assigned the role of master and the first detection apparatus and the second detection apparatus each being assigned the role of slave.

6. The position input system according toclaim 4, wherein,
when the position indicator is assigned the role of master and the first detection apparatus is assigned the role of slave, the controller performs the communication control to add the second detection apparatus that is assigned the role of slave to the one-to-one network to newly construct the one-to-many network.

7. The position input system according toclaim 4, wherein,
under a condition that the one-to-many network including the position indicator that is assigned the role of master and the first detection apparatus and the second detection apparatus each being assigned the role of slave is constructed,
when the connection between the second detection apparatus and the position indicator is to be ended, the controller performs the communication control to further end the connection between the first detection apparatus and the position indicator and then construct the one-to-one network including the position indicator that is assigned the role of slave and the first detection apparatus that is assigned the role of master.

8. The position input system according toclaim 3, wherein
the controller
classifies states of the position detection apparatuses belonging to a group included in the one-to-many network into a used state and an unused state, and
performs the communication control to make polling intervals for the position detection apparatuses in the used state shorter than polling intervals for the position detection apparatuses in the unused state.

9. The position input system according toclaim 3, wherein
the position indicator is an electronic pen that is capable of measuring a pen pressure applied to a pen tip, and
the electronic pen transmits a polling signal including pen pressure information related to the pen pressure to each of the position detection apparatuses, when being assigned the role of master.

10. A position indicator used along with a plurality of position detection apparatuses that receive indication of a position, the position indicator comprising:
a wireless communication circuit that uses a master-slave system to perform wireless communication with each of the position detection apparatuses; and
a controller connected to the wireless communication circuit and configured to perform communication control of the wireless communication circuit to switch roles of master and slave according to the number of the position detection apparatuses connected at a same time.

11. A communication method using a position input system, the position input system including a position indicator for indicating a position, and a plurality of position detection apparatuses that receive the indication by the position indicator, the communication method comprising:
using, by the position indicator, a master-slave system to perform wireless communication with each of the position detection apparatuses; and
switching, by the position indicator or the position detection apparatuses, roles of master and slave according to the number of the position detection apparatuses connected at a same time.
